(19) United States
(12) Patent Application Publication
(10) Pub. No.: US 2012/0151111 A1
(43) Pub. Date: Jun. 14, 2012

(54) APPARATUS AND METHOD OF PROCESSING INTERRUPT FOR IMPROVING USER INPUT PROCESSING PERFORMANCE IN MOBILE DEVICE VIRTUALIZATION ENVIRONMENT

(75) Inventor: Young Woo JUNG, Seoul (KR)

(73) Assignee: Electronics and Telecommunications Research Institute, Daejeon (KR)

(21) Appl. No.: 13/305,991

(22) Filed: Nov. 29, 2011

(30) Foreign Application Priority Data
Dec. 10, 2010 (KR) 10-2010-0126433

(51) Int. Cl. G06F 13/24

(52) U.S. Cl. 710/263

(57) ABSTRACT

Provided is an apparatus of processing an interrupt, the apparatus including: an interrupt queue storing the input device interrupt when a target virtual machine to process an input device interrupt generated by a user input device is not scheduled; and an interrupt inspector judging whether a processing time of the input device interrupt stored in the interrupt queue reaches a threshold and when the processing time of the input device interrupt reaches the threshold, granting a priority higher than an initial value to the virtual machine to process the corresponding interrupt.

### CROSS-REFERENCE TO RELATED APPLICATIONS

This application claims priority to and the benefit of Korean Patent Application No. 10-2010-0126433 filed in the Korean Intellectual Property Office on Dec. 10, 2010, the entire contents of which are incorporated herein by reference.

### TECHNICAL FIELD

The present invention relates to an apparatus and a method of processing interrupt for improving user input processing performance in a mobile device virtualization environment. More particularly, the present invention relates to an apparatus and a method of processing interrupt capable of improving user input processing performance in a mobile device virtualization environment in which multiple operating systems are simultaneously executed.

### BACKGROUND

Presently, user input devices requiring an immediate response such as a touch screen, a keypad, and the like have been used in mobile devices. In addition, in order to simultaneously run multiple operating systems, mobile device virtualization technology is applied to execute the operating systems in virtual machines, respectively and a virtual machine monitor performs scheduling of multiple virtual machines.

However, scheduling polices used in the current mobile device virtualization technology schedule multiple virtual machines evenly or periodically by reserving resources in order to ensure CPU usages of each virtual machines. Therefore, because the scheduling of the virtual machine that should process interrupt generated in the user input device requiring the immediate response is delayed, interrupt processing is delayed, thereby not satisfying a user response time requirement.

Meanwhile, if the corresponding virtual machine is scheduled whenever the interrupt is generated in the user input device, context switching between virtual machines occurs too frequently, so system performance is degraded intensely.

Further, when the interrupt of the same type occurs again while the interrupt has not been processed, the interrupt that previously occurred cannot be processed and disappears.

### SUMMARY

The present invention has been made in an effort to improve user input processing performance by enhancing an interrupt processing scheme for a user input device in a mobile device virtualization environment.

More specifically, in the case where a virtual machine that will process the interrupt of the user input device is not in the scheduled state, the corresponding interrupt is stored in an interrupt queue within a virtual machine monitor and in the case where a processing time of the corresponding interrupt reaches a threshold, the corresponding interrupt is processed as soon as possible by giving a higher priority to the virtual machine with interrupt to be processed, and as a result, input processing delay can be minimized, preventing the interrupt from being omitted.

An exemplary embodiment of the present invention provides a method of processing an interrupt, including: inspecting whether input device interrupts which have not been processed are in the interrupt queue when some interrupt is generated; inspecting whether the generated interrupt is an input device interrupt generated by a user input device when the unprocessed input device interrupts are not present in the interrupt queue; inspecting whether a target virtual machine to process the corresponding interrupt is scheduled when the generated interrupt is the input device interrupt generated by the user input device; and storing the generated interrupt in the interrupt queue when the target virtual machine is not in the scheduled state.

The method may further include inspecting whether a target virtual machine to process the corresponding input device interrupt is scheduled when the unprocessed input device interrupt is present in the interrupt queue.

The method may further include judging whether a processing time of the earliest stored interrupt among the interrupts stored in the interrupt queue reaches a threshold when the target virtual machine to process the corresponding input device interrupt is not in the scheduled state.

The method may further include granting the priority higher than an initial value to the target virtual machine to process the corresponding interrupt, when the processing time of the earliest input device interrupt stored in the interrupt queue reaches the threshold.

The method may further include: when the target virtual machine to process the corresponding input device interrupt is scheduled, transferring the unprocessed input device interrupt in the interrupt queue to the target virtual machine; and when the priority of the target virtual machine is higher than the initial value, changing the priority of the target virtual machine to the initial value.

Another exemplary embodiment of the present invention provides an apparatus of processing an interrupt, including: an interrupt queue storing the input device interrupts when the target virtual machine to process an input device interrupt generated by a user input device is not scheduled; and an interrupt inspector judging whether a processing time of the input device interrupt stored in the interrupt queue reaches a threshold and when the processing time of the input device interrupt reaches the threshold, granting a higher priority than an initial value to the virtual machine to process the corresponding interrupt.

The interrupt inspector may inspect whether an input device interrupt not transferred to the corresponding virtual machine is stored in the interrupt queue when the interrupt is generated.

The present invention provides the following effect.

According to exemplary embodiments of the present invention, in order to improve processing performance for a user input device, in the case where a virtual machine that will process the interrupt of the user input device is not in the scheduled state, the corresponding interrupt is stored in an interrupt queue within a virtual machine monitor and in the case where a processing time of the corresponding interrupt reaches a threshold, the corresponding interrupt is processed by giving a higher priority to a virtual machine with interrupt to be processed, and as a result, input processing delay can be minimized, preventing the interrupt from being omitted.

### BRIEF DESCRIPTION OF THE DRAWINGS

FIG. 1 is a diagram showing an interrupt system adopting an apparatus of processing interrupt for improving user input processing in a mobile device virtualization environment according to an exemplary embodiment of the present invention; and

FIG. 2 is a flowchart showing a method of processing interrupt for improving user input processing performance in a mobile device virtualization environment according to an exemplary embodiment of the present invention.

### DETAILED DESCRIPTION

Hereinafter, exemplary embodiments of the present invention will be described in detail with reference to the accompanying drawings. In this description, when any one element is connected to another element, the corresponding element may be connected directly to another element or with a third element interposed therebetween. First of all, it is to be noted that in giving reference numerals to elements of each drawing, like reference numerals refer to like elements even though like elements are shown in different drawings. The components and operations of the present invention illustrated in the drawings and described with reference to the drawings are described as at least one exemplary embodiment and the spirit and the core components and operation of the present invention are not limited thereto.

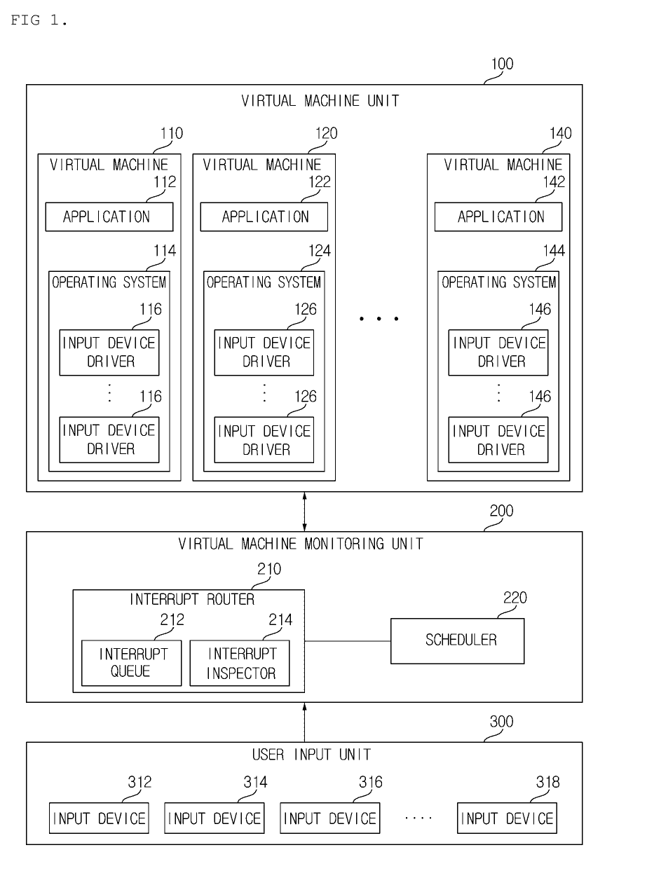

FIG. 1 is a diagram showing an interrupt system adopting an apparatus of processing interrupt for improving user input processing in a mobile device virtualization environment according to an exemplary embodiment of the present invention.

Referring to FIG. 1, an input processing apparatus according to the exemplary embodiment of the present invention includes a virtual machine unit 100, a virtual machine monitor unit 200, and a user input unit 300.

The user input unit 300 includes input devices 312, 314, 316, and 318 such as a touch screen, a keypad, and the like which are peripheral devices of a mobile device, and transfers interrupt generated by operating a user input device to the virtual machine monitor unit 200.

The virtual machine monitor unit 200 supports a CPU, a memory, and input/output virtualization of the mobile device to simultaneously execute multiple operating systems that operate in the virtual machine unit 100 and separate execution environments of the individual operating systems from each other.

More specifically, the virtual machine monitor unit 200 includes an interrupt router 210 processing interrupt generated from an input device in which a processing time is important among the plurality of input devices included in the user input unit 300. The interrupt router 210 includes an interrupt queue 212 storing interrupt which does not reach the virtual machine unit 100 because the virtual machine that should process the interrupt generated in the user input unit 300 is not scheduled and an interrupt inspector 214 determining whether a processing time of the interrupt stored in the interrupt queue 212 reaches a threshold and granting a higher priority to the virtual machine that will process the corresponding interrupt when the processing time of the stored interrupt reaches the threshold.

In addition, the virtual machine monitor unit 200 includes a scheduler 220 scheduling virtual machines included in the virtual machine unit 100. The scheduler 220 context-switches the virtual machines according to a predetermined scheduling algorithm.

The virtual machine unit 100 includes multiple virtual machines 110, 120, and 140 where applications 112, 122, and 142 and operating systems 114, 124, and 146 operate. Drivers for the input devices of the user input unit 300 are provided in the operating systems in the virtual machines, and particularly, input device drivers 116, 126, and 146 are provided in each operating system and the drivers used in not a virtual environment but a general environment may be used without modification.

In a virtualized environment, all interrupts generated in the user input unit 300 are transferred to the virtual machine monitor unit 200 and the virtual machine monitor 200 transfers the interrupts generated in the user input unit 300 to the operating system in the corresponding virtual machine.

Meanwhile, the virtual machine monitor unit 200 corresponds to the interrupt processing apparatus disclosed in Claims and Detailed Description of the present invention.

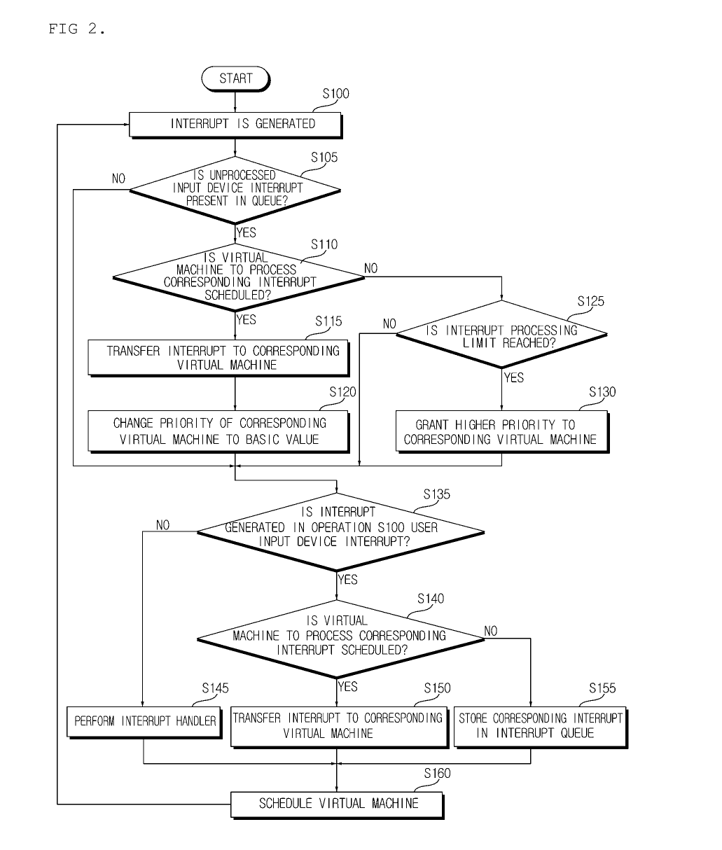

FIG. 2 is a flowchart showing a method of processing interrupt for improving user input processing performance in a mobile device virtualization environment according to an exemplary embodiment of the present invention.

Referring to FIG. 2, in the case where a virtual machine monitor unit has a control right, exception processing including interrupt occurs. When the interrupt is generated (S100), the virtual machine monitor unit inspects whether the interrupt is stored in an interrupt queue before processing the interrupt generated in operation S100 (S105).

According to the inspection result in operation S105, in the case where a previously stored interrupt is stored in the interrupt queue, the virtual machine monitor unit inspects whether a virtual machine that should process the stored interrupt is scheduled (S110).

According to the inspection result in operation S110, when the virtual machine that should process the stored interrupt is scheduled, the interrupts stored in the interrupt queue are sequentially transferred to the corresponding machine and the transferred interrupt is processed (S115). In addition, when the priority of the corresponding virtual machine is set higher than a basic value (initial value) for processing the interrupt, the priority of the corresponding virtual machine is changed to the basic value (S120).

If the virtual machine that should process the stored interrupt is not scheduled according to the inspection result in operation step S110, the virtual machine monitor unit judges whether a processing time of the earliest stored interrupt among the interrupts stored in the interrupt queue reaches a threshold (S125).

According to the judgment result in operation S125, when the processing time of the corresponding interrupt reaches the threshold, the corresponding interrupt should be processed as quickly as possible, and as a result, the priority of the target virtual machine that should process the corresponding interrupt is set higher than the initial value (S130).

Next, the virtual machine monitor unit inspects whether the interrupt generated in operation S100 is an interrupt generated in an input device of a user input unit (S135).

According to the inspection result in operation S135, when the corresponding interrupt is the user input device interrupt generated in the input device of the user input unit, the virtual machine monitor unit inspects whether the virtual machine that should process the corresponding interrupt is scheduled (S145).

According to the inspection result in operation S145, when the virtual machine that should process the corresponding interrupt is scheduled, the interrupt is transferred to the corresponding virtual machine and the interrupt is processed (S150).

If the virtual machine that should process the corresponding interrupt is not scheduled according to the inspection result in operation S145, the corresponding interrupt is stored in the interrupt queue (S155).

Meanwhile, when the interrupt generated in operation S100 is not the interrupt generated in the input device of the user input unit, the process proceeds to operation S140 to process the interrupt by performing a general interrupt handler (S140).

Lastly, while the processing of the interrupt generated in operation S100 is completed, the virtual machine is scheduled according to a scheduling algorithm of a scheduler and thereafter, when the interrupt is generated, the process proceeds to operation S105 to repetitively perform the above-mentioned process.

According to exemplary embodiments of the present invention, in order to improve processing performance for a user input device, in the case where a virtual machine that will process the interrupt of the user input device is not in a scheduling state, the corresponding interrupt is stored in an interrupt queue through a virtual machine monitor and in the case where a processing time of the corresponding interrupt reaches a threshold, the corresponding interrupt is processed by giving a higher priority to a virtual machine with interrupt to be processed, and as a result, input processing delay can be minimized, preventing the interrupt from being omitted.

As described above, the exemplary embodiments have been described and illustrated in the drawings and the specification. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method of processing an interrupt, comprising:
inspecting whether an input device interrupt which is not processed is stored in an interrupt queue when the interrupt is generated;
inspecting whether the generated interrupt is an input device interrupt generated by a user input device when the unprocessed input device interrupt is not present in the interrupt queue;
inspecting whether a target virtual machine to process the corresponding interrupt is scheduled when the generated interrupt is the input device interrupt generated by the user input device; and
storing the generated interrupt in the interrupt queue when the target virtual machine is not scheduled.

2. The method of claim 1, further comprising: inspecting whether a target virtual machine to process the corresponding input device interrupt is scheduled when the unprocessed input device interrupt is present in the interrupt queue.

3. The method of claim 2, further comprising: judging whether a processing time of the earliest stored interrupt among the interrupts stored in the interrupt queue reaches a threshold when the target virtual machine to process the corresponding input device interrupt is not scheduled.

4. The method of claim 3, further comprising: when the processing time of the earliest input device interrupt stored in the interrupt queue reaches the threshold, granting the priority higher than an initial value to the target virtual machine to process the corresponding interrupt.

5. The method of claim 2, further comprising: when the target virtual machine to process the corresponding input device interrupt is scheduled, transferring the unprocessed input device interrupt in the interrupt queue to the target virtual machine; and
when the priority of the target virtual machine is higher than the initial value, changing the priority of the target virtual machine to the initial value.

6. An apparatus of processing an interrupt, comprising:
an interrupt queue storing the input device interrupt when a target virtual machine to process an input device interrupt generated by a user input device is not scheduled; and
an interrupt inspector judging whether a processing time of the input device interrupt stored in the interrupt queue reaches a threshold and when the processing time of the input device interrupt reaches the threshold, granting a higher priority than an initial value to the virtual machine to process the corresponding interrupt.

7. The apparatus of claim 6, wherein the interrupt inspector inspects whether an input device interrupt not transferred to the corresponding virtual machine is stored in the interrupt queue when the interrupt is generated.
